(19) United States
(12) Patent Application Publication
(10) Pub. No.: US 2007/0225463 A1
(43) Pub. Date: Sep. 27, 2007

(54) Method for dehydrating biomass

(76) Inventors: Michael John Femal, Arlington Heights, IL (US); Robert Clyde Stephenson, Appleton, WI (US); Frederick M. Tegge, Appleton, WI (US); David A. Stringham, Appleton, WI (US); David A. Schwerbel, Menasha, WI (US); Jon Howard Kellett, Geneva, IL (US)

Correspondence Address: Michael J. Femal;Attorney at Law, 812 N. Belmont Ave., Arlington Heights, IL, 60004-5606, US

(21) Appl. No.: 11/389,704

(22) Filed: Mar. 27, 2006

(51) Int. Cl. C08H 5/02

(52) U.S. Cl. 527/400

(57) ABSTRACT

Organic substrates such as grain by-products: wet cake, mash, stillage, wet brewers cake are dewatered in a relatively low energy, low-heated gas flow, negative pressure, four stage process consisting of leaching with organic solvent, mechanical dewatering, evaporation and reclamation of the organic solvent in an environment of a stable gas flow. The dried organic substrate is processed into a dry distiller's grains with solubles which is free-flowing quality substance suitable for food or other uses at much lower substrate drying temperatures generally below 200° F. Conveniently, the solvent and the stable gases are recovered from the water-solvent leaching and dewatering process by a distillation tower and feedback loop system allowing the recycling of the solvent and stable gas while reducing the level of air emissions in the unique drying system.

The present invention relates to an improved method for dewatering biomass, and more particularly the application of this method to dehydrating biomass by-products, aka “co-products”, such as wet cake, mash, silage, and brewers' cake generated in the production of industrial grade ethanol (“ethanol process”).

### BACKGROUND OF THE INVENTION

These by-products are typically the insoluble solid organic substrate resultant materials from ethanol production plants. In particular, the ethanol production plants, for the purposes of the present invention, utilize what is known in the industry as the “dry-grind” or “dry mill” process. The invention has applicability to distillers dried grains produced in other types of ethanol plants, including but not limited to those using the “wet mill” process. The dehydrated by-products are known as Distillers Dried Gain with Solubles (DDGS), Distillers Modified Wet Grains (DMWG), and generic distiller grains. These products are commonly used as animal feed supplements, but because of their nutritional values, may have other uses as well.

This method consumes less energy by substantially lowering the drying temperatures and thereby reducing the amount of evaporative emissions of undesirable volatile organic compounds (“VOCs”) and other air emissions. And again the lower drying process temperatures helps to maintain the nutritional value of the biomass more than other prior art processes and methods used for dehydrating these various substances.

Presently, corn is the most commonly used grain for the commercial production of ethanol fuel. Most of the ethanol production plants utilize a dry milling process, but some use wet milling. Our focus for the present invention is the drying milling process of corn for ethanol production. The corn is dry-milled into a meal, Then, digestive enzymes are added, liquefying the meal in conjunction with the breakdown of the carbohydrates into sugars and producing a porridge-like material known as corn mash. The mash is fermented to produce ethanol and carbon dioxide and the resultant ethanol is distilled off. In the ethanol process, when the resultant ethanol is distilled off, the remaining whole stillage leaves an insoluble, biomass by-product addressed by this invention. The substrates, however, may come from corn, rice, wheat or any other suitable grain or biomass material that lends itself to this inventive process. The present invention assists the ethanol production to be a no-waste process that adds value to the corn by converting the left-over biomass by-products into more valuable products.

The remaining insoluble, biomass by-product is then physically separated by screening or centrifuging into two streams:
1.) An insoluble substrate commonly known as “wet distillers grains” or “wet cake”; and
2.) the liquid portion containing fine suspended particles of biomass, commonly known as condensed distiller's solubles, or “syrup”, which can be further dehydrated through evaporators and recovered for further use in the process.

The “wet cake” has a high nutritional value and is presently, commonly used as animal feed. Left in its un-dehydrated state, this material decomposes, making it unsuitable for consumption relatively rapidly and making it desirable to extend that period of use. It has been found that the desired effect of extending the period of use can be achieved by dehydration of the biomass through a drying process to create the DDGS at approximately 14% water content or less.

Additionally, since wet cake directly from the ethanol process is comprised of approximately 63-67% water, transporting this material containing a significant amount of water to market can be economically unfeasible, especially over a wide geographical area. The difficult economics of shipping and distributing heavy and bulky (high-water-content) material provides further incentive for dehydration. The conventional technology for extending the quality of this substrate is by further dehydration by evaporating the water content, typically in a drum or fluidized bed dryer, producing the DDGS by-product at the 14% water content or less. The common conditions for dehydrating the substrate in these conventional dryers consist of the addition of heat, the movement of air and the movement of the biomass substrate. This process consists of heating the biomass particulate solids, which is achieved by passing the biomass being processed through a current of hot air, evaporating the moisture. The air stream can be directed either in the same direction as the biomass is traveling through the dryer (co-current) or in the opposite direction (counter-current). Co-current dryers are used in most general drying applications, but are less efficient, requiring a larger amount of heat and thus a larger expenditure of energy costs to accomplish the drying. Counter-current drying systems are more efficient in terms of energy input but result in elevated product temperatures. Elevated temperatures during the drying process can destroy the nutritional value of the DDGS and remove the vitamins therein.

So, the factors affecting the rate of drying of the wet cake and its final moisture content are:
1.) The time that the wet cake is exposed to the relevant temperature;
2.) the amount of air flow across the substrate during the drying process; and
3.) the degree of particle separation and thus, the degree of exposure of the particle to the air flow during the drying process.

In these methods, the temperature of the air flowing over the substrate is often elevated to temperatures approximately between 212 and 1292 degrees Fahrenheit or even higher in some instances. These methods can only be applied to biomass substrates that can withstand exposure to these elevated temperatures for a predetermined time without undergoing severe physical and chemical degradation or quality changes to the final DDGS product. Temperatures in excess of certain predetermined degrees Fahrenheit depending on the substrate material used in the ethanol production degrade the nutritional value as well as the vitamin content of the biomass for feed since many vitamins flash off at these elevated temperatures during the drying process or even in the ethanol production process.

Some solid organic substrates demand mixing dry with wet material to maintain particle separation or flow through the conventional drum drying systems at fairly elevated temperatures well over 212° F. affecting the final DDGS product. The constant mixing of additional wet material in with the drying material in a typical drum dryer system at the higher temperatures is done to help prevent the scorching or burning of the biomass substrate during the drying process. In this scenario, the solid organic substrates must be processed over and over again by continuous tumbling or feeding the substrates through the drum dryer system employed. Obviously, the step of multiple processing and drying operations destroys nutritional value, vitamin content, flavor, color and other beneficial elements of a good DDGS product, and is inefficient from an energy standpoint and the time to process the DDGS.

The conventional prior art methods of dehydrating biomass substrates result in undesirable VOCs and other air emissions from the drying process at these elevated or high temperatures. The exhaust gas stream from these methods inevitably includes fine particles, significant amounts of water vapor, heat, volatile organic compounds, carbon monoxide, nitrogen oxides, and other pollutants. While technologies for abating emissions of these materials, including various filters, scrubbers, and oxidizers, are commonly known and applied, their application increases the energy consumption and associated operating and maintenance costs. The operating cost of these abatement processes for the air emissions can exceed the operating cost of the dehydration process itself.

Therefore the disadvantages of existing prior art dehydration technologies for the production of DDGS are:
1. High energy consumption;
2. Repeating processing steps that are detrimental to the quality of the end product from a nutritional and vitamin content;
3. Inefficient and time consuming steps; and
4. Emission of regulated air pollutants that require additional energy consumption and hardware for abatement and control.

The above listed factors found in the prior art processes for drying wet grains to produce the final DDGS end-product led to the degradation of the product from excessive time and heat needed to thoroughly dry the wet cake to a predetermined level of water content to produce the particular level of dryness in DDGS for use as an animal feed. In conventional drum drying techniques, the continuous exposure of the wet cake to elevated temperatures during the drying process over an extended period of time (whether using a co-current or a counter-current drying system and whether or not wet cake is added to the partially dried substrate materials during the drying process as done in some plant facilities to avoid scalding or scorching of the end product) is a major factor in all such processes that results in the loss of taste, color, protein and other vital nutrients in the final DDGS product.

Therefore, any improvement in the dehydration process of the wet cake that reduces the energy requirements and temperatures used to process the wet cake into DDGS, maintains the quality of the DDGS, and reduces air emissions subject to air pollution control requirements resulting from the wet cake drying process, is a most desirable outcome for ethanol production plants.

Moreover, a more efficient and less costly method for dehydrating this wet cake by-product into DDGS will enable a wider area of distribution for the sale of the end product. Thus, this method utilizing lower drying temperatures provides a broader range of customers for the end-product and thus a more stable market. The method increases the yield and reduces the energy in the production of DDGS. The end result is increased operating profit, for example, by the ethanol producers. Further, it is important to employ a process for the continuous production of dried solid organic substrate that reduces the time to produce the DDGS because the typical ethanol fuel plant produces hundreds of tons of wet cake each day during ethanol production.

### SUMMARY OF THE INVENTION

In the present invention, a higher quality nutritional DDGS product is produced with less energy consumption, lower drying temperatures and less regulated air emissions than with the current prior art drying of wet cake to produce the DDGS end products of 14% moisture or less in water content. The resultant dehydrated solid organic substrate, or DDGS, is a granular, free flowing material suitable for food use.

Also, in the event a customer desires a “Distillers Modified Wet Grains” that has a specification of approximately 48% moisture achieved after drying the coarse grains down to approximately 40% moisture and then adding the syrup (suspended fine grains) back in to bring admixture up to specification, or any desired moisture level between the Distillers Modified Wet Grains and the DDGS.

Accordingly, it is an object of the present invention to reduce energy consumption by utilizing an organic solvent like alcohol to disperse the particles in the wet cake and to combine with the water content therein. The substrate or wet cake is mechanically dehydrated and then the remaining alcohol/water solvent mixture is evaporated off the wet cake during a low heat drying stage that keeps the substrate biomass below approximately 200 degrees Fahrenheit in a milling process while the alcohol is recovered and reused in the process. Required energy is reduced because the specific heat of vaporization of the solvent mixture during the drying and subsequent distillation step is approximately 60% less than that of water alone.

It is further an object of the invention to dehydrate the substrate under substantially lower temperatures with limited air flow across the substrate in the final drying process and at a slight negative pressure, recapturing and reclaiming waste gases, and reducing the volume of regulated air emissions.

It is another object of the invention to preserve the initial food quality of the substrate by limiting the time and drying temperature of the process to a predetermined level that is far less than known prior art drying techniques.

It is still further another object of the invention to use the alcohol and carbon dioxide in a feedback loop system that includes a vacuum to achieve the lower temperatures and faster drying times for transforming wet cake into DDGS.

Yet another object of the present invention is to create a drying process for a biomass derived through the ethanol manufacturing process from such starch-containing grains as corn, rice, sorghum, barley and wheat, amongst other types of similar grains, in which the biomass is transformed into a nutritional DDGS at substantially lowered drying temperatures than prior art drying processes.

Other features and advantages of the invention, which are believed to be novel and nonobvious, will be apparent from the following specification taken in conjunction with the accompanying drawing in which there is shown a preferred embodiment of the invention. Reference is made to the claims for interpreting the full scope of the invention, which is not necessarily represented by any one embodiment.

### BRIEF DESCRIPTION OF THE DRAWINGS

FIG. 1 shows an overall block diagram of a hydrated organic substrate or wet cake material introduced into a drying process with steps in accordance with the present invention.

### DETAILED DESCRIPTION

Although this invention is susceptible to embodiments of many different forms, a preferred embodiment will be described and illustrated herein. The present disclosure exemplified the principles of the invention and is not to be considered a limit to the broader aspects of the invention to the particular embodiment as described.

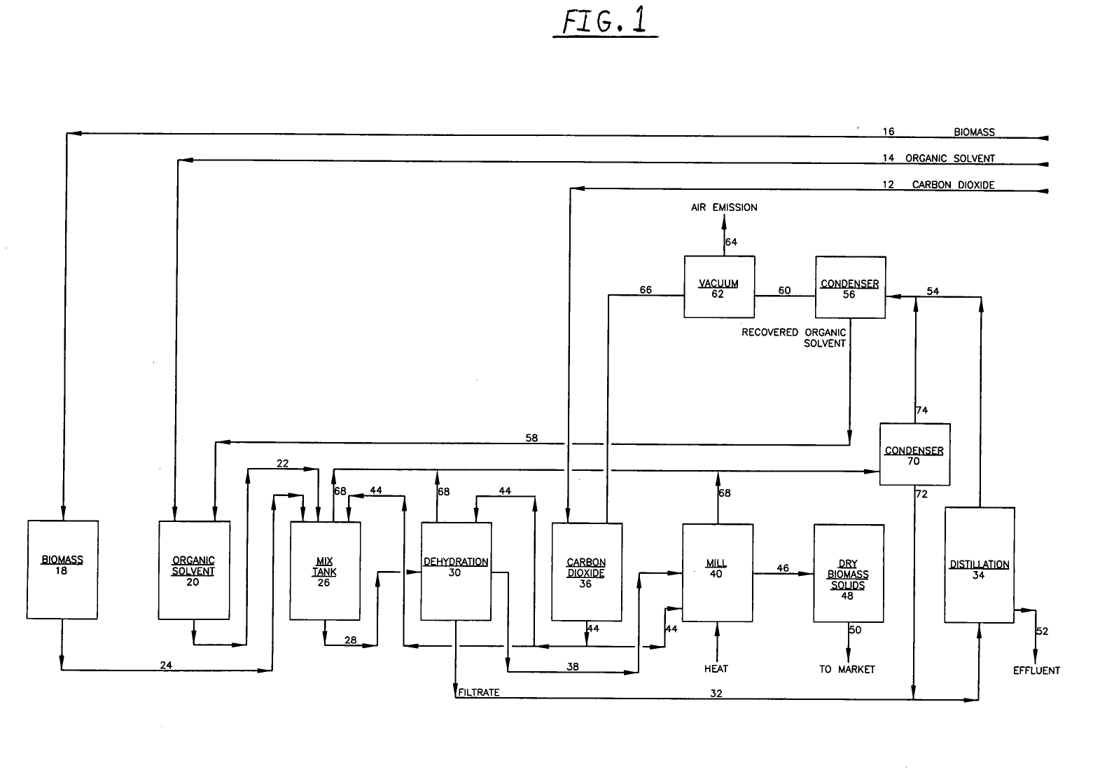

FIG. 1 shows a block flow diagram of the steps in the dehydration system and process for an organic substrate biomass produced as a by-product of an ethanol production system. This invention dehydrates an organic substrate such as wet cake derived from a corn base in a predetermined negative pressure, in a heated and limited air flow environment that keeps the organic substrate below approximately 200° F. in a four stage process comprising the steps of leaching with an organic solvent, mechanical and then pneumatic dewatering of the organic substrate and finally, the complete recovery of the organic solvent for reuse in the process.

One of the steps involves mixing an organic solvent such as alcohol with the hydrated organic substrate such as a wet cake produced during ethanol production. The organic solvent acts to mix with the water and to disperse the particles of the substrate, allowing the particles to be mechanically and then pneumatically dehydrated more efficiently at a later step in the process.

Another step involves further dehydration of the organic substrate by evaporation of a water-solvent mixture at a negative pressure. This step requires less energy than the prior art processes for three reasons:

There is less moisture to be evaporated because the substrate has been previously dewatered mechanically:
1.) less heat is required because most of the water has been replaced with an organic solvent which has a lower specific heat of vaporization than water thereby reducing the amount of heat required to dry the organic substrate in a final milling stage; and
2.) the negative pressure further reduces the level of heat required for vaporization of organic solvent in the substrate during the final drying stage.

Another step in the process is related to maintaining the process at a lower temperature that maintains the food quality of the by-product DDGS and reduces the loading of volatile gas emissions subject to regulation.

Another important feature of the invention is conducting the drying process of a hydrated organic substrate in an environment of a relatively inert and stable atmosphere, maintaining a non-explosive atmosphere during the drying process because of the vacuum or negative pressure being pulled on the feedback loop system allowing the lower temperatures during the final drying process.

Yet another important feature of the invention is that the drying process or system is conducted in a feedback loop system at a negative pressure, with limited gas flow, recirculating and reclaiming gases in the process and thereby minimizing air emissions.

Turning now to FIG. 1, an overall process system 10 in accordance with the present invention includes an incoming source of carbon dioxide (CO2) 12, an organic solvent (such as alcohol) 14 and a biomass 16. The biomass 16 a.k.a. wet cake or wet grains comes into the process either with the syrup or solubles from the evaporation stage of ethanol production already sprayed onto or mixed into the biomass 16 before it enters into the novel drying process of the present invention or it is inserted into a stage of the present invention to be described later. The source of carbon dioxide 12 comes directly from the fermentation stage of ethanol production, which can produce large quantities of food-grade carbon dioxide as a co-product of production. Next the organic solvent 14 typically comes directly from the dehydration stage of the ethanol production where the alcohol is called anhydrous (pure, without water) and is approximately 200 proof. As previously stated, the biomass 16 is wet corn grains, or wetcake, that is fed to a biomass storage tank 18. The organic solvent 14, or alcohol, is fed into an organic solvent storage tank 20.

Thus, the incoming hydrated solid organic substrate 16 such as a corn-based wet cake is continuously discharged to the biomass tank 18. The organic solvent 14 enters the system 10 and is stored in the solvent tank 20 as needed in the process. The organic solvent 14 and wet cake biomass 16 via lines 22 and 24, respectively, are transferred independently to the top end of a mix tank 26 where they are mixed together. Moreover, if the biomass 16 comes into the system 10 without the syrup added therein, the mix tank 26 is such a stage where the syrup or solubles from the ethanol production can be mixed into the biomass 16 to produce the final DDGS.

A mixture comprised of organic solvent 14 and the biomass 16 is transferred via line 28 to a dehydrator device 30 such as a centrifuge, which mechanically and partially dewaters the substrate. During the initial dehydration, a filtrate is produced and transferred via the filtrate line 32 to a distillation tower 34 to be described later.

Meanwhile, the carbon dioxide 12 is fed to a carbon dioxide tank 36 for further use to be described later in the process. The partially dehydrated substrate 16 with a reduced water content coming from the dehydration device 30 is then transferred via a dehydrated mixture line 38 to a mill 40 where the partially dehydrated substrate is turned repeatedly, exposing the solid particles within the substrate to heat and airflow across the substrate, further dehydrating the substrate material being processed into DDGS. A source of heat 42 such as boiling water or steam at approximately 212° F. or higher forms a water jacket around the mill 40 that heats the airflow across the substrate and provides an easy means to control the heat applied within the chamber of the mill 40 to a predetermined level to achieve the desired drying conditions for the final DDGS product. Since the organic solvent in the material boils off into a vapor gas at substantially less than 200° F., the substrate biomas in the mill 40 seldom exceeds temperatures of approximately 170° F. to 200° F. plus or minus several degrees in temperature during the further drying process in the mill 40. In fact, such a source of heat 42 in the Mill 40 allows the substrate to be heated to approximately 200° F. or less but since the solvent and water mixture evaporates off the organic substrate when it reaches a temperature in the approximate range of 160 to 180+° F., the substrate biomass within the Mill 40 seldom if ever reaches the highest temperature of approximately 200° F. This process protects the final DDGS product from being burned or having further nutrients and vitamins flashing off due to the elevated temperatures typically seen in prior art drum dryers that reach several hundred degrees Fahrenheit in temperature within the drying chambers during the drying process which requires them to keep adding moist wet cake into the drying process to prevent the burning or scorching of the organic substrate being dried.

In addition, the mill 40 could be a point where vitamins such as vitamin A and others driven off during the ethanol production process are added back into the DDGS final product at the end of the mill 40 either at or before the substrate is transported out of the mill 40 since the temperatures in the mill 40 during drying are generally well below the heat flash point where most vitamins are typically driven off from the DDGS. Also, during this process carbon dioxide 12 is introduced into the mill 40 via a carbon dioxide feeder line 44 which splits into several different paths to connect to other stages within the system 10.

When a predetermined point of dryness of the organic substrate occurs the resulting dry biomass 16 is then transferred from the mill 40 via a dry biomass feeder line 46 where vitamins also are capable of being added into the DDGS as it moves into a dry biomass solids storage tank 48. Later a storage truck, rail car or other receptacle is placed below a market feed transfer line 50 that fills the truck, rail car, or receptacle with DDGS of a predetermined moisture content for distribution of the end product. So at this point, the biomass or DDGS has been dehydrated to a predetermined moisture content of generally 14% or less and is discharged via the line 46 into the Dry Biomass Tank 48 for end use.

Referring now to the filtrates from the Dehydration device 30, the filtrates are then transferred via line 32 to the bottom of the Distillation Tower or Distillation Stage 34 for further processing. The filtrate at the distillation tower 34 is distilled, reclaiming the organic solvent 14 as a vapor and discharging any condensed water during the distillation process through a water discharge line 52. The same source of water jacketed heat at approximately 212° F. is applied to the bottom of the distillation tower 34 and is stratified across its height to an exit temperature of approximately 173° F. at the top of the distillation tower 34. The filtrate, which is principally a water/solvent mixture as it leaves the dehydration vessel 30 and is fed into the bottom of the tower at its hottest point with some solids, is broken down where the solvent is evaporated off by the heat leaving the water with the suspended solids to be discharged through the discharge line 52.

In addition, a predetermined and regulated flow of carbon dioxide 12 is fed from the carbon dioxide tank 36 through the feeder line 44 to a vapor discharge line 54 at the top of the distillation tower 34 to assist the movement of the solvent vapor as the organic solvent rises up through the tower 34 to the vapor discharge line 54 that travels from the top of the distillation tower 34 to a condenser 56 that separates the carbon dioxide 12 from the organic solvent vapors 14. The preferably condenser 56 utilizes water versus air to reduce the energy consumption but, an air condenser is also possible to use. The recovered organic solvent or alcohol 14 is then transferred from the condenser 56 via a recovered organic solvent line 58 back to the organic solvent tank 20 to complete a feedback loop for the alcohol 14. The separated carbon dioxide 12 and other air emissions that do not condense are then discharged from the condenser on another output line 60 to a vacuum pump or centrifugal fan vessel 62 where the much reduced volatile air emissions are either vented to the atmosphere on an air emissions discharge line 64 or captured for further processing or treatment. In short, there is a negative pressure or partial vacuum on the line 60 between the condenser 56 and vacuum pump 62 and a positive pressure on line 66 back to the carbon dioxide storage tank 36. Meanwhile, the CO2 is fed back into the carbon dioxide storage tank 36 by the positive pressure on an outlet line 66 from the vacuum source 62.

Again, the solvent vapors from the distillation tower 34 are pulled along by means of the vacuum source 62, such as a vacuum pump or centrifugal fan, into the condenser 56 where the solvent vapors are condensed into the liquid organic solvent 14 of approximately 180 proof as it is fed back through transfer line 58 into the organic solvent tank 20. The CO2 feeder line 44 provides CO2 to the mix tank 26, the dehydrator 30 and the mill 40 at a slightly positive pressure. The vacuum source 62 pulls vapors including CO2 through the condenser feed line 68 from the mix tank 26, dehydrator 30 and mill 40 at a slightly negative pressure to a condenser 70 having a filtrate line 72 connecting to filtrate line 32. The vapor from the condenser 70 is pulled through a line 74 connecting to line 54.

Carbon Dioxide (CO2) 12 is a stable gas that enters the system 10 and is stored in the Carbon Dioxide Tank 36. The CO2 is then introduced at various points in the process and acts as a carrier for solution vapors and other air emissions within the system. As a gas, CO2 does not condense and therefore, it is discharged under positive pressure as a gas from the vacuum source 62 and returned through transfer line 66 to the Carbon Dioxide Tank 36. CO2 provides a non-explosive atmosphere within the system 10 during the mixing, dehydration and milling steps that prevents an oxygen-enriched atmosphere from occurring, that might lead to a potential fire or explosion hazard in the process. Therefore, the use of CO2 or any other stable, non-condensable gas is an important element in this invention.

The mixture of the alcohol 14 with the hydrated wet cake 16 allows the dehydration device 30 to work more effectively with the lower temperatures required to dry the dewatered wet cake that is feed into the mill 40 for the remainder of the drying process to reach the predetermined moisture level for the DDGS end product.

Further the primary principle is limiting overall air emissions by recirculation of the gases in the dehydration system of the present invention. By design, a feedback loop air system limits the air volume in the system. A negative pressure or partial vacuum, created by the vacuum source 62 in the feedback loop system, increases evaporation, as liquid boils at lower temperatures in a partial vacuum. Moreover, the lower operating temperatures during the dehydration process to produce the end product, DDGS, helps to maintain the quality of the final DDGS product and limits the overall energy costs. Next, limiting the processing time to dehydrate the biomass 16 in conjunction with the lower heat of the substrate biomass below 200° F. and generally below approximately 170° F. at which the solvent evaporates during the process supports and overall drying process that provides a cleaner and cooler environment that also limits the amount of VOCs and other air emissions.

An organic solvent is used for at least two purposes:
1. As a solvent, to enable the substrate to be dewatered more efficiently, and
2. To partially replace water in the substrate with the organic solvent, which has a lower specific heat of vaporization, enabling the substrate to be further dewatered in a subsequent drying stage of the invention utilizing lower heat and thereby using less energy.

The primary principle of this invention is to reduce the overall energy required to dehydrate the substrate to a predetermined level while maintaining nutritional value and limiting gaseous emissions. In part, this is achieved by replacing water with an organic solvent, which has a lower specific heat of vaporization, thus requiring less energy to dewater the substrate during the drying process.

In addition, this efficiency is further enhanced by operating the system under partial vacuum, accelerating vaporization as liquids boil at lower temperatures in a vacuum, further reducing the specific heat of vaporization water/solvent mixture and further enhancing energy efficiency.

Having described and illustrated the principles of the invention in a preferred embodiment thereof, it should be apparent that the invention can be modified in arrangement and detail without departing from the spirit and scope of the invention as claimed.

I/We claim:

1. A method of drying a hydrated biomass produced from an ethanol process to use as a food, comprising the steps of:
(a) mixing the hydrated biomass with a predetermined amount of organic solvent to create a water-solvent mixture within the biomass;
(b) dehydrating the biomass to a predetermined moisture content by removing the water-solvent mixture as a filtrate from the biomass;
(c) milling the dehydrated biomass for exposing the substrate particles thereof to a dry, heated gas to change the biomass into a dry distillers grains with solubles (DDGS) at a predetermined moisture content of approximately 14% or less;
(d) introducing a source of stable, gaseous compound into the mixing and milling steps and into other various points within a feedback loop system associated with the drying of the biomass to create a non-volatile atmosphere for processing the biomass;
(e) distilling the filtrate to separate the solvent from the water by evaporation in a generally stratified temperature atmosphere to draw off the solvent as a vapor for reclamation and to remove the water by discharging it;
(f) condensing the reclaimed solvent vapor and returning the solvent for reuse again in the feedback loop system; and
(g) creating a generally negative pressure within the feedback loop system to move the solvent vapors from the mixing, dehydrating, milling and distilling steps to the condensing step and to draw off the stable gaseous compound and other vapors and air emissions vented from the mixing, dehydrating and milling steps to the condensing step for reuse of the stable, gaseous compound and for discharge or further processing of the other non-condensable gases and air emissions.

2. The method of claim 1, wherein the hydrated biomass is subjected to temperatures of 200° F. or less during the dehydration and drying process to prevent burning or degradation of the biomass.

3. The method of claim 1, wherein the biomass in the drying process is derived from a grain such as corn, rice, barley, sorghum or wheat, among others.

4. The method of claim 1, wherein the stable gaseous compound is carbon dioxide source.

5. The method of claim 1, wherein the dehydrating step of the biomass is accomplished by a mechanical centrifuge for removing the solvent-water mixture as a filtrate to a predetermined level before the biomass is fed to the milling step.

6. The method of claim 1, further comprising the steps of:
(h) utilizing a heat for drying in the milling step wherein the biomass stays below approximately 200° F. or less and wherein the solvent vapors and other air emissions are drawn off into the feedback loop system for reuse or for further processing and treatment; and
(i) operating the milling step at a temperature sufficient to reclaim 100% of the remaining organic solvent from the biomass without degradation occurring while the biomass is being transformed into the DDGS product.

7. The method of claim 1, wherein the negative pressure is created by a vacuum source, such as a pump, or centrifugal fan, drawing the solvent vapors and stable gaseous compound through the feedback loop system back to storage tanks within the system for reuse in the process.

8. An apparatus for dehydrating an organic substrate created as a by-product in ethanol production to provide a substantially dry, free-flowing end product having properties enabling its use as a food for humans or animals, comprising:
a feedback loop system for processing the gases within the dehydration processing of the organic substrate;
a mixing vessel for mixing a hydrated organic substrate with an organic solvent to form a water-solvent mixture therein;
a source for introducing the organic solvent into the mixing vessel in a predetermining ratio;
a source of the hydrated organic substrate for introducing the hydrated organic substrate into the mixing vessel in a predetermined ratio;
a dehydration vessel using mechanical force to partially remove the water-solvent mixture from the hydrated organic substrate as a filtrate for further processing;
a mill agitating and passing a heated gas over the partially dehydrated organic substrate to further remove any remaining organic solvent as a vapor and to dry the dehydrated organic substrate to a predetermined level of moisture by weight of the organic substrate in its transformation to a dry distillers grains with solubles;
a source of CO2 connected to the mixing vessel and to the mill to create a non-volatile atmosphere during the mechanically dewatering in the mixing vessel and during the final drying of the organic substrate to a predetermined level of moisture in the milling vessel, respectively;
a distillation tower for separating the water-solvent filtrate into solvent vapors and water for reclaiming the solvent as a liquid for reuse and for discharging the water from the distillation tower and the process; and
a negative pressure applied throughout the feedback loop system to assist the flow of reclaimed gases such as solvent vapors and CO2 while moving other non-condensable gases for discharge from the system or further processing or treatment while creating lower operating temperatures during the final drying process wherein the organic substrate stays below approximately 200° F. or less for drying the organic substrate in a non-volatile atmosphere; and
wherein the quality of the DDGS end product is less degraded in flavor, color and uniformity.

9. The apparatus of claim 8, wherein the dehydration vessel is a mechanical centrifuge that is used in removing water from the hydrated organic substrate.

10. The apparatus of claim 8, wherein the mill is a mechanical mill including a chamber at one end with a vacuum pipe to draw off the solvent vapors and other gases emitting from the organic substrate as it is dried to the predetermined moisture level wherein approximately 100% of the organic solvent is released from the dehydrated organic substrate and recovered for reuse through said vacuum pipe.

11. The apparatus of claim 8, wherein the distillation tower is connected to the filtrate drain line from the dehydration vessel to further process and separate the water-solvent filtrate into its constituent parts of water and solvent for recovery of the organic solvent as a vapor and for discharge of the water from the tower and the apparatus while reducing regulated air emissions during the drying process.

12. The apparatus of claim 8, wherein the distillation tower includes inlets and outlets wherein one inlet is connected to a drain line from the dehydration vessel carrying the water-solvent filtrate and entering approximately at the bottom of the tower to be heated to a predetermined heat at or about 212° F. in which the solvent distills off as a vapor and the water vapors condense and are discharged through a first outlet at the bottom of the distillation tower while the solvent vapors rise up through the distillation tower to exit at a second outlet at the top of the distillation tower so that the solvent vapors can be condensed in a condenser for recovery of organic solvent as a liquid fed back to the organic solvent source and the CO2 and other non-condensable gases and air emissions are vented from the mixing, dehydration and milling vessels to connect to the second outlet of the distillation tower as a negative pressure at the second outlet of the distillation tower pulls the solvent vapors, CO2, non-condensable gases and other air emissions to the condenser for recovery or discharge.

13. A hydrated organic substrate drying system, comprising:
a mixing device for mixing the hydrated organic substrate with a low molecular weight organic solvent;
a mechanical device connected to the mixing device for partially removing the water-solvent mixture from the hydrated organic substrate;
a heated milling device connected to the mechanical device for removing any remaining solvent as a gas from the substrate and reducing the moisture content of a generally dehydrated organic substrate to a predetermined moisture level to transform the organic substrate into a DDGS; and
a feedback loop system for gases within the drying system connected to said devices for introducing and venting gases from the mixing, mechanical and milling devices to assist in the removal of the moisture from the hydrated organic substrate at substrate temperatures generally below 200° F. while operating at a slightly negative pressure within the drying system thereby creating a non-volatile atmosphere for drying the organic substrate and for recirculating the gases at a predetermined flow level to recover certain gases for reuse and to discharge other gases from the system in order to produce a quality dry distillers grain with solubles as a by-product for human or animal consumption.

14. The drying system of claim 13, wherein the mixing device is an agitating tank with a stirrer.

15. The drying system of claim 13, wherein the solvent is alcohol.

16. The drying system of claim 13, wherein the negative pressure is a vacuum source in circuit with the feedback loop system.

17. The drying system of claim 13, wherein the organic substrate is derived from corn, wheat, barley, rice or other grain with fiber, protein, fat, energy, minerals and other nutritional content.

18. The drying system of claim 13, wherein the mechanical device is a mechanical centrifuge having a filtrate discharge tube for partially removing the water-solvent mixture from the hydrated organic substrate.

19. The drying system of claim 13, wherein the predetermined level of moisture in the DDGS is in a range of approximately 3-40% by weight.

20. The drying system of claim 13, wherein the organic solvent is an alcohol selected from the group consisting of methanol, ethanol or isomers thereof.
